(19) United States
(12) Patent Application Publication
(10) Pub. No.: US 2026/0148987 A1
(43) Pub. Date: May 28, 2026

(54) POSITIVE ELECTRODE SLURRY FOR RECHARGEABLE LITHIUM BATTERY, POSITIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Gi Hun JUNG, Suwon-si (KR); Eui Soo JEONG, Suwon-si (KR); Sun Dae KIM, Suwon-si (KR); Bo Mee KWON, Suwon-si (KR); Jin Ah SEO, Suwon-si (KR); E Rang CHO, Suwon-si (KR); Yeon A KIM, Suwon-si (KR); Jae Kwang KIM, Suwon-si (KR); Jin Hyeok LIM, Suwon-si (KR); Sang Hoon KIM, Suwon-si (KR)

(73) Assignee: SAMSUNG SDI CO., LTD., Yongin-si (KR)

(21) Appl. No.: 19/399,818

(22) Filed: Nov. 25, 2025

(30) Foreign Application Priority Data
Nov. 26, 2024 (KR) 10-2024-0171048

(51) Int. Cl. H01M 4/62; H01M 4/36; H01M 4/38; H01M 4/525; H01M 4/587; H01M 10/0525

(52) U.S. Cl. CPC H01M 4/62; H01M 4/364; H01M 4/386; H01M 4/525; H01M 4/587; H01M 4/623; H01M 4/625; H01M 10/0525

(57) ABSTRACT

A positive electrode slurry for a rechargeable lithium battery, a positive electrode for a rechargeable lithium battery, and a rechargeable lithium battery including the positive electrode are disclosed. The positive electrode slurry for a rechargeable lithium battery includes a positive electrode active material, a binder, a positive electrode additive, and a conductive material.

### CROSS-REFERENCE TO RELATED APPLICATION

The present application claims priority to Korean Patent Application No. 10-2024-0171048, filed on Nov. 26, 2024, in the Korean Intellectual Property Office, the entire disclosure of which is incorporated herein by reference.

### BACKGROUND

### 1. Field of the Disclosure

The present disclosure relates to a positive electrode slurry for a rechargeable lithium battery, and a rechargeable lithium battery including the positive electrode slurry.

### 2. Discussion of Related Art

With increasing use of electronic devices using batteries such as, e.g., mobile phones, laptop computers, electric vehicles, and the like, the demand for rechargeable batteries with high energy density and high capacity has increased. Accordingly, improving the performance of rechargeable lithium batteries may be advantageous.

A rechargeable lithium battery typically includes positive and negative electrodes that include active materials capable of intercalation and deintercalation of lithium ions, and an electrolyte, and produces electrical energy through oxidation and reduction reactions when the lithium ions are intercalated/deintercalated into/from the positive and negative electrodes.

As the electrolyte of such rechargeable lithium batteries, an electrolyte in which a lithium salt is dissolved in a non-aqueous organic solvent is typically used. Rechargeable lithium batteries exhibit battery characteristics through complex reactions between the positive electrode and the electrolyte, between the negative electrode and the electrolyte, and the like. Therefore, the use of a desired electrolyte is a relevant parameter in improving the performance of rechargeable lithium batteries.

### SUMMARY

One example embodiment includes a positive electrode slurry for a rechargeable lithium battery capable of implementing a positive electrode for a rechargeable lithium battery that provides a high capacity retention rate and a low resistance increase rate after storage at high temperatures.

According to an example aspect of the present disclosure, a positive electrode slurry for a rechargeable lithium battery includes a positive electrode active material, a binder, a positive electrode additive, and a conductive material, wherein the positive electrode additive includes a compound of the following Chemical Formula 1:

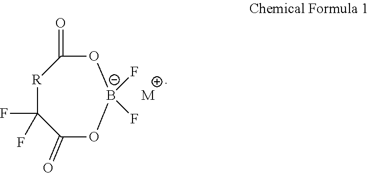

R and M are as described in the description of the present disclosure below.

According to another example aspect of the present disclosure, a rechargeable lithium battery includes a positive electrode manufactured using the slurry of positive electrode active material, and a negative electrode including a negative electrode active material.

### BRIEF DESCRIPTION OF THE DRAWINGS

The following drawings illustrate example embodiments of the present disclosure and further describe aspects and features of the present disclosure together with the detailed description of the present disclosure. Thus, the present disclosure should not be construed as being limited to the drawings, in which:

FIG. 1 is a conceptual diagram schematically showing a rechargeable lithium battery according to one example embodiment of the present disclosure.

FIG. 2 to FIG. 5 are cross-sectional views schematically showing rechargeable lithium batteries according to example embodiments.

### DETAILED DESCRIPTION

In order to fully understand the configurations and effects of the present disclosure, example embodiments of the present disclosure are described below with reference to the accompanying drawings. However, it should be understood that the example embodiments disclosed below may be embodied in various forms and modified in various ways without being limited to the example embodiments described herein. However, the description of the example embodiments is provided only to ensure that the disclosure of the present disclosure is made complete, and to fully inform a person having ordinary skill in the art to which the present disclosure belongs of the scope of the present disclosure.

In the present specification, when any component is referred to as being “on” another component, it means that the component may be formed directly on the other component, or a third component may be interposed therebetween. Also, in the drawings, the thicknesses of components may be exaggerated for the effective description of the technical contents. Throughout the present specification, parts denoted by the same reference numerals denote the same components.

Unless otherwise specified in the present specification, anything indicated in the singular may also include the plural. In addition, unless otherwise particularly stated herein, “A or B” may mean “including A, including B, or including A and B.” As used in the present specification, the term “comprise” and/or “comprising” do not exclude the presence or addition of one or more other components.

In the present specification, the term “combination thereof” may refer to a mixture, laminate, composite, copolymer, alloy, blend, reaction product, and the like of components.

Unless otherwise defined in the present specification, the term “substituted” means that at least one hydrogen in a substituent or compound is replaced with at least one of deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

For example, the term “substituted” may mean that at least one hydrogen in a substituent or compound is replaced with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may mean that at least one hydrogen in a substituent or compound is replaced with deuterium, a halogen group, a C1 to C20 alkyl group, a C6 to C30 aryl group, a C1 to C10 fluoroalkyl group, or a cyano group. Alternatively, the term “substituted” may mean that at least one hydrogen in the substituent or compound is replaced with deuterium, a halogen group, a C1 to C5 alkyl group, a C6 to C18 aryl group, a C1 to C5 fluoroalkyl group, or a cyano group. As an example, the term “substituted” may mean that at least one hydrogen in the substituent or compound is replaced with deuterium, a cyano group, a halogen group, a methyl group, an ethyl group, a propyl group, a butyl group, a phenyl group, a biphenyl group, a terphenyl group, a trifluoromethyl group, or a naphthyl group.

Unless otherwise particularly defined in the present specification, the symbol “*” refers to a moiety that is connected to the same or different atom or chemical formula. Unless specifically mentioned in the chemical formulas described in the present specification, it may be seen that hydrogen is bonded in the structure of the chemical formula.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

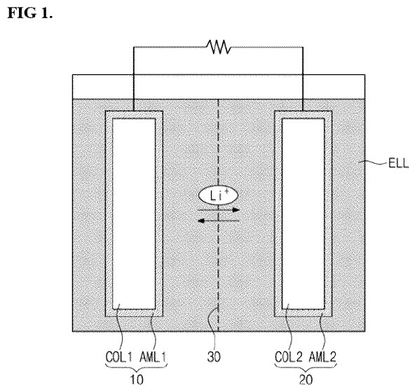

FIG. 1 is a conceptual diagram schematically showing a rechargeable lithium battery according to one example embodiment of the present disclosure. Referring to FIG. 1, the rechargeable lithium battery may include a positive electrode 10, a negative electrode 20, a separator 30, and an electrolyte (ELL).

The positive electrode 10 and the negative electrode 20 may be spaced apart from each other with the separator 30 interposed therebetween. The separator 30 may be disposed between the positive electrode 10 and the negative electrode 20. The positive electrode 10, the negative electrode 20 and the separator 30 may be in contact with the electrolyte (ELL). The positive electrode 10, the negative electrode 20 and the separator 30 may be impregnated with the electrolyte (ELL).

The electrolyte (ELL) may be or include a medium for transferring lithium ions between the positive electrode 10 and the negative electrode 20. In the electrolyte (ELL), the lithium ions may pass through the separator 30 to move toward the positive electrode 10 or the negative electrode 20.

### Positive Electrode 10

A positive electrode 10 for a rechargeable lithium battery may include a current collector (COL1) and a positive electrode active material layer (AML1) formed on the current collector (COL1). The positive electrode active material layer (AML1) includes a positive electrode active material, and may further include a binder and/or a conductive material.

As an example, the positive electrode 10 may further include an additive that may constitute a sacrificial positive electrode.

The content of the positive electrode active material in the positive electrode active material layer (AML1) may range from about 90% by weight to about 99.5% by weight based on 100% by weight of the positive electrode active material layer (AML1). The contents of the binder and conductive material may each range from about 0.5% by weight to about 5% by weight based on 100% by weight of the positive electrode active material layer (AML1).

The binder adheres positive electrode active material particles to each other, and also adheres the positive electrode active material to the current collector (COL1). Representative examples of the binder include at least one of polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but the present disclosure is not limited thereto.

The conductive material may impart conductivity to the electrodes, and any material may be used as long as the material is electronically conductive without causing adverse chemical changes in the battery to be formed. Examples of the conductive material include carbon-based materials such as at least one of natural graphite, artificial graphite, carbon black, acetylene black, Ketjen black, carbon fibers, carbon nanofibers, carbon nanotubes, and the like; metal-based materials in the form of metal powder or metal fibers containing at least one of copper, nickel, aluminum, silver, and the like; conductive polymers such as polyphenylene derivatives and the like; or a mixture thereof.

Al may be used as the current collector (COL1), but the present disclosure is not limited thereto.

### Positive Electrode Active Material

As the positive electrode active material in the positive electrode active material layer (AML1), a compound capable of reversible intercalation and deintercalation of lithium (lithiated intercalation compound) may be used. For example, at least one of a composite oxide of lithium and a metal such as or including at least one of cobalt, manganese, nickel, and a combination thereof may be used.

The composite oxide may be or include a lithium transition metal composite oxide, and examples thereof include at least one of a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

As an example, the positive electrode active material may be or include a high-nickel positive electrode active material in which the content of nickel is about 80 mol % or more, 85 mol % or more, 90 mol % or more, 91 mol % or more, or 94 mol % or more, and 99 mol % or less, based on 100 mol % of metals excluding lithium in the lithium transition metal composite oxide. The high-nickel positive electrode active material may achieve high capacity, and thus may be applied to high-capacity, high-density rechargeable lithium batteries.

### Negative Electrode 20

A negative electrode 20 for a rechargeable lithium battery includes a current collector (COL2), and a negative electrode active material layer (AML2) disposed on the current collector (COL2). The negative electrode active material layer (AML2) includes a negative electrode active material, and may further include a binder and/or a conductive material.

For example, the negative electrode active material layer (AML2) may include about 90% by weight to about 99% by weight of the negative electrode active material, about 0.5% by weight to about 5% by weight of the binder, and about 0% by weight to about 5% by weight of the conductive material.

The binder adheres negative electrode active material particles to each other, and also adheres the negative electrode active material to the current collector (COL2). Anon-aqueous binder, an aqueous binder, a dry binder, or a combination thereof may be used as the binder.

The non-aqueous binder includes at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the aqueous binder may further include a cellulose-based compound capable of imparting viscosity. As the cellulose-based compound, one or more types of carboxymethyl cellulose, hydroxypropylmethyl cellulose, methyl cellulose, or alkali metal salts thereof may be mixed and used. At least one of Na, K or Li may be used as the alkali metal.

The dry binder is a fiberizable polymeric material, and may be or include, for example, at least one of polytetrafluoroethylene, polyvinylidene fluoride, a polyvinylidene fluoride-hexafluoropropylene copolymer, polyethylene oxide, or a combination thereof.

The conductive material may impart conductivity to the electrodes, and any material may be used as long as the material is electronically conductive without causing adverse chemical changes in the battery to be formed. Examples include carbon-based materials such as at least one of natural graphite, artificial graphite, carbon black, acetylene black, Ketjen black, carbon fibers, carbon nanofibers, carbon nanotubes, and the like; metal-based materials in the form of metal powder or metal fibers containing at least one of copper, nickel, aluminum, silver, and the like; conductive polymers such as polyphenylene derivatives and the like; or a mixture thereof.

A current collector including at least one of copper foil, nickel foil, stainless steel foil, titanium foil, a nickel foam, a copper foam, a polymer substrate coated with a conductive metal, and a combination thereof may be used as the current collector (COL2).

### Negative Electrode Active Material

The negative electrode active material in the negative electrode active material layer (AML2) includes at least one of a material capable of reversible intercalation/deintercalation of lithium ions, a lithium metal, an alloy of lithium and a metal, a material capable of doping and dedoping lithium, or a transition metal oxide.

The material capable of reversible intercalation/deintercalation of lithium ions may include a carbon-based negative electrode active material, for example, crystalline carbon, amorphous carbon, or a combination thereof. Examples of the crystalline carbon include graphite such as amorphous, plate-like, flaky, spherical, or fibrous natural or artificial graphite, and examples of the amorphous carbon include at least one of soft carbon or hard carbon, mesophase pitch carbide, calcined coke, and the like.

As the alloy of lithium and a metal, an alloy of lithium and a metal such as or including at least one of Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-based negative electrode active material or a Sn-based negative electrode active material may be used. The Si-based negative electrode active material may be or include at least one of silicon, a silicon-carbon composite, SiOₓ (0<x<2), a Si-Q alloy (wherein Q is or includes at least one of an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to one example embodiment, the silicon-carbon composite may be in the form of silicon particles which surfaces are coated with amorphous carbon. For example, the silicon-carbon composite may include a secondary particle (core) in which silicon primary particles are assembled, and an amorphous carbon coating layer (shell) disposed on the surface of the secondary particle. The amorphous carbon may also be located between the silicon primary particles, and for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer disposed on the surface of the core.

The Si-based negative electrode active material or the Sn-based negative electrode active material may be used in combination with a carbon-based negative electrode active material.

### Separator 30

A separator 30 may be present between the positive electrode 10 and the negative electrode 20 depending on the type of rechargeable lithium battery. As the separator 30, at least one of polyethylene, polypropylene, polyvinylidene fluoride, or a multi-layer film of two or more layers thereof may be used. For example, a mixed multi-layer film such as or including at least one of a polyethylene/polypropylene two-layer separator, a polyethylene/polypropylene/polyethylene three-layer separator, a polypropylene/polyethylene/polypropylene three-layer separator, and the like may also be used.

The separator 30 may include a porous substrate and a coating layer including an organic material, an inorganic material, or a combination thereof and disposed on one surface, or on both surfaces of the porous substrate.

The porous substrate may be or include a polymer film formed of or including any one polymer such as or including at least one of polyolefins such as polyethylene, polypropylene, and the like, polyesters such as polyethylene terephthalate, polybutylene terephthalate, polyethylene naphthalate and the like, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fibers, Teflon, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, Ga₂O₃, ZnO, ZrO₂, Y₂O₃, SrTiO₃, BaTiO₃, Mg(OH)₂, boehmite, and a combination thereof, but the present disclosure is not limited thereto.

The organic and inorganic materials may be present as a mixture in one coating layer, or may be present in a form in which a coating layer including an organic material and a coating layer including an inorganic material are laminated.

### Electrolyte (ELL)

An electrolyte (ELL) for a rechargeable lithium battery includes a non-aqueous organic solvent and a lithium salt.

The non-aqueous organic solvent constitutes a medium through which ions involved in the electrochemical reaction of the battery may move.

The non-aqueous organic solvent may be or include at least one of a carbonate-based, ester-based, ether-based, ketone-based, or alcohol-based solvent, an aprotic solvent, or a combination thereof.

As the carbonate-based solvent, at least one of dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), and the like may be used.

As the ester-based solvent, at least one of methyl acetate, ethyl acetate, n-propyl acetate, dimethyl acetate, methyl propionate, ethyl propionate, decanolide, mevalonolactone, valerolactone, caprolactone, and the like may be used.

As the ether-based solvent, at least one of dibutyl ether, tetraglyme, diglyme, dimethoxyethane, 2-methyltetrahydrofuran, 2,5-dimethyltetrahydrofuran, tetrahydrofuran, and the like may be used. Cyclohexanone and the like may be used as the ketone-based solvent. Ethyl alcohol, isopropyl alcohol, and the like may be used as the alcohol-based solvent. At least one of nitriles such as R—CN (where R is a linear, branched, or cyclic hydrocarbon group having 2 to 20 carbon atoms and may include a double bond, an aromatic ring, or an ether group) and the like; amides such as dimethylformamide and the like; dioxolanes such as 1,3-dioxolane, 1,4-dioxolane, and the like; and sulfolanes, may be used as the aprotic solvent.

The non-aqueous organic solvents may be used alone, or in combination of two or more solvents.

When the carbonate-based solvent is used, a cyclic carbonate and a chain carbonate may be used in combination, and the cyclic carbonate and the chain carbonate may be mixed in a volume ratio in a range of about 1:1 to about 1:9.

The lithium salt is a material that dissolves in an organic solvent and thus constitutes a source of lithium ions in the battery, thereby allowing the basic operation of a rechargeable lithium battery, and promotes the movement of lithium ions between the positive and negative electrodes. Representative examples of the lithium salt may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI), LiC₄F₉SO₃, LiN(CₓF₂ₓ₊₁SO₂)(CyF_{2y+1}SO₂) (where x and y are integers in a range from 1 to 20), lithium trifluoromethane sulfonate, lithium tetrafluoroethanesulfonate, lithium difluorobis(oxalato)borate (LiDFOB), lithium difluorobis(oxalato)phosphate (LiDFOP), and lithium bis(oxalato) borate (LiBOB), bis(trifluoromethanesulfonyl)imide (LiTFSI), Lithium Tetrafluoro Oxalato Phosphate (LiTFOP).

### Rechargeable Lithium Battery

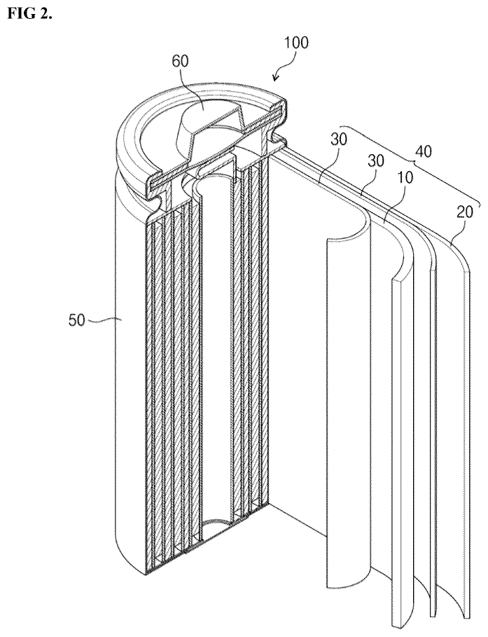

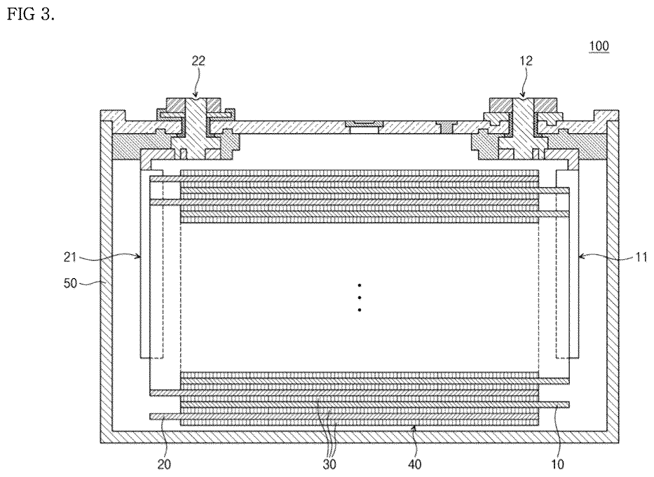

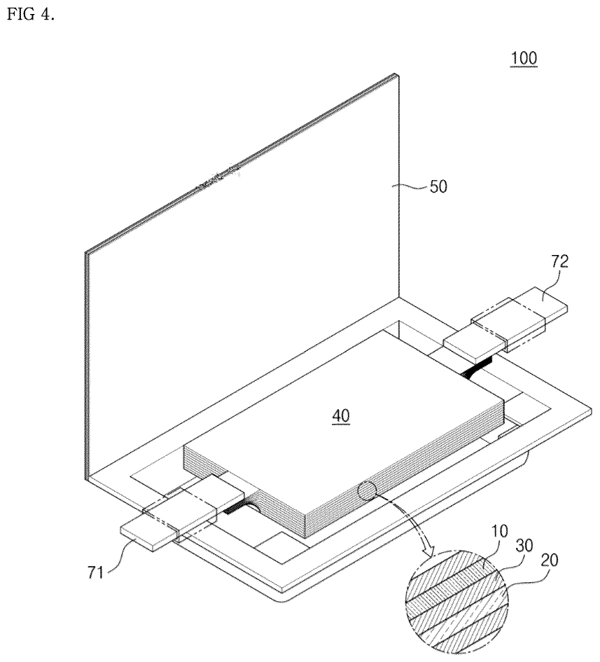

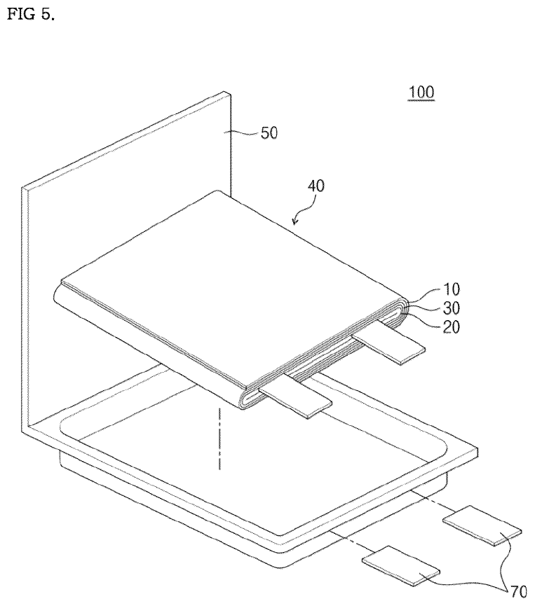

Rechargeable lithium batteries may be classified into cylindrical, prismatic, pouch-type, and coin-type rechargeable lithium batteries depending on the type of rechargeable lithium battery. FIG. 2 to FIG. 5 are diagrams schematically showing rechargeable lithium batteries according to example embodiments: The rechargeable lithium batteries can be said to be cylindrical, prismatic, and pouch-type batteries, as shown in FIG. 2, FIG. 3, FIG. 4 and FIG. 5, respectively. Referring to FIG. 2 to FIG. 4, a rechargeable lithium battery 100 may include an electrode assembly 40 having a separator 30 interposed between a positive electrode 10 and a negative electrode 20, and a case 50 in which the electrode assembly 40 is built. The positive electrode 10, the negative electrode 20, and the separator 30 may be impregnated with an electrolyte (not shown). The rechargeable lithium battery 100 may include a sealing member 60 configured to seal the case 50 as shown in FIG. 2. Also, as shown in FIG. 3, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 4 and FIG. 5, the rechargeable lithium battery 100 may include electrode tabs 70 illustrated in FIG. 5, or a positive electrode tab 71 and a negative electrode tab 72 illustrated in FIG. 4, the electrode tabs 70/71/72 forming electric paths configured to conduct current formed in the electrode assembly 40 to the outside of the battery 100.

Hereinafter, a positive electrode slurry for a rechargeable lithium battery according to one example embodiment of the present disclosure is described in more detail.

The positive electrode slurry for a rechargeable lithium battery includes a positive electrode active material, a binder, a positive electrode additive, and a conductive material, wherein the positive electrode additive includes a compound of the following Chemical Formula 1:

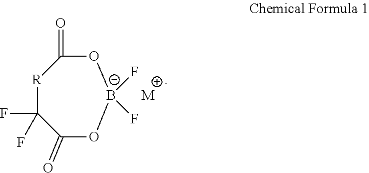

R is or includes at least one fluorine-substituted C1 to C20 alkylene group, and
M is or includes an alkali metal.

In one example embodiment, the alkali metal may be or include at least one of lithium, sodium, potassium, rubidium, or cesium. For example, M may be or include lithium or sodium, or lithium.

In one example embodiment, R may be or include at least one of a fluorine-substituted C1 to C10 alkylene group, a fluorine-substituted C1 to C5 alkylene group, or a fluorine-substituted C1 to C3 alkylene group.

In one example embodiment, R may be or include at least one of a perfluoro-substituted C1 to C10 alkylene group, a perfluoro-substituted C1 to C5 alkylene group, or a perfluoro-substituted C1 to C3 alkylene group.

For example, R may be or include —CHF—, —CF₂—, —C₂HF₃—, —C₂H₂F₂—, —C₂H₃F—, —C₂F₄—, —C₃F₆—, —C₃HF₅—, —C₃H₂F₄—, —C₃H₃F₃—, —C₃H₄F₂—, —C₃H₅F—, —C₄F₈—, —C₄HF₇—, —C₄H₂F₆—, —C₄H₃F₅—, —C₄H₄F₄—, —C₄H₅F₃—, —C₄H₆F₂—, —C₄H₇F—, —C₅F₁₀—, —C₅HF₉—, —C₅H₂F₈—, —C₅H₃F₇—, —C₅H₄F₆—, —C₅H₅F₅—, —C₅H₆F₄—, —C₅H₇F₃—, —C₅H₈F₂—, or —C₅H₉F—. For example, R may be —CHF—, —CF₂—, —C₂F₄—, —C₃F₆—, —C₄F₈—, or —C₅F₁₀—.

In one example embodiment, the compound of Chemical Formula 1 may include one or more of compounds of the following Chemical Formulas 1-1 and 1-2:

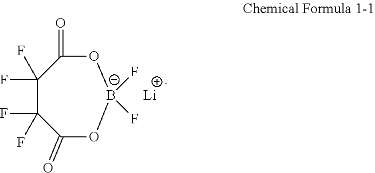 [SMILES: O=C1O[B-](F)(F)OC(=O)C(F)(F)C1(F)F ; [Li+]]

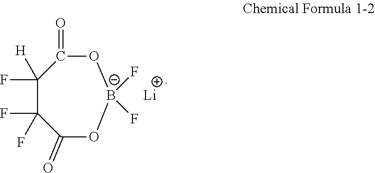 [SMILES: O=C1O[B-](F)(F)OC(=O)C(F)(F)C1F ; [Li+]]

The compound of Chemical Formula 1 may be included in the positive electrode slurry for a rechargeable lithium battery to provide a positive electrode for a rechargeable lithium battery that exhibits a high capacity retention rate and a low resistance increase rate after storage at high temperatures. For example, when the compound of Chemical Formula 1 is included in the positive electrode slurry including a high-nickel positive electrode active material having a high nickel content as a positive electrode active material, the compound may improve the battery lifespan after storage at high temperatures and reduce the deterioration of battery performance at high temperatures.

The compound of Chemical Formula 1 may be included in an amount in a range of about 0.1 parts by weight to about 10 parts by weight based on 100 parts by weight of the positive electrode active material. The content of the compound of Chemical Formula 1 may be the content of the compound of Chemical Formula 1 in the positive electrode slurry based on 100 parts by weight of the total weight of the positive electrode active material in the positive electrode slurry. In the above content range, a positive electrode exhibiting a high capacity retention rate and a low resistance increase rate after storage at high temperatures may be provided. For example, the compound of Chemical Formula 1 may be included in an amount in a range of about 0.1 parts by weight to about 5 parts by weight, 0.1 parts by weight to 3 parts by weight, 0.5 parts by weight to 2 parts by weight, or 1 parts by weight to 2 parts by weight based on 100 parts by weight of the positive electrode active material.

The compound of Chemical Formula 1 may be manufactured by a conventional method known to those skilled in the art.

The positive electrode slurry may include the above-described lithium transition metal composite oxide as the positive electrode active material. For example, the positive electrode slurry may include at least one of a lithium nickel-based oxide, a lithium cobalt-based oxide, a lithium manganese-based oxide, a lithium iron phosphate-based oxide, a cobalt-free nickel manganese-based oxide, or a combination thereof.

In one example embodiment, the positive electrode slurry may include a lithium nickel-based oxide. For example, the lithium nickel-based oxide may be represented by the following Chemical Formula 2:

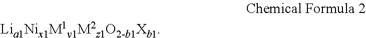

In Chemical Formula 2, 0.9≤a1≤1.8, 0.3≤x1≤1, 0≤y1≤0.7, 0<z1≤0.7, 0.9≤x1+y1+z1≤1.1, and 0≤b1≤0.1, M¹ and M² each independently is or includes one or more of Al, B, Ba, Ca, Ce, Co, Cr, Cu, Fe, Mg, Mn, Mo, Nb, Si, Sn, Sr, Ti, V, W, and Zr, and X is or includes one or more of F, P, and S.

In Chemical Formula 2, 0.6≤x1≤1, 0≤y1≤0.4, and 0≤z1≤0.4, or 0.8≤x1≤1, 0≤y1≤0.2, and 0≤z1≤0.2.

As an example, the positive electrode active material may be or include a high-nickel positive electrode active material in which the nickel content is 80 mol % or more, 85 mol % or more, 90 mol % or more, 91 mol % or more, or 94 mol % or more and 99 mol % or less, based on 100 mol % of metals excluding lithium in the lithium nickel-based oxide. The high-nickel positive electrode active material may implement high capacity, and thus may be applicable to high-capacity, high-density rechargeable lithium batteries.

In one example embodiment, the lithium nickel-based oxide may be included in an amount of about 95% by weight or more, for example, in a range of about 95% to about 100% by weight, 99% to 100% by weight, or 100% by weight, in the positive electrode active material.

The binder may include one or more of the binders described for the above-described positive electrode.

In one example embodiment, the binder may include a fluorine-based binder. For example, the fluorine-based binder may include a fluorine-substituted hydrocarbon resin. For example, the fluorine-substituted hydrocarbon resin may include at least one of polyvinylidene fluoride (PVDF), a vinylidene fluoride-hexafluoropropylene copolymer (PVDF-co-HFP), and the like.

The conductive material may include one or more of the conductive materials described for the above-described positive electrode.

In one example embodiment, the conductive material may include one or more of artificial graphite and carbon black.

The positive electrode active material, the conductive material and the binder included in the positive electrode slurry may be included in amounts in a range of about 90 parts by weight to about 99 parts by weight, a range of about 0.5 parts by weight to about 5 parts by weight, and a range of about 0.5 parts by weight to about 5 parts by weight, respectively, based on a total of 100 parts by weight of the positive electrode active material, the conductive material, and the binder.

The positive electrode slurry may further include a dispersion medium.

The dispersion medium may include a polar organic solvent, for example, N-methyl-2-pyrrolidone, or the like.

The dispersion medium may be included in an amount in a range of about 15% to about 30% by weight in the positive electrode slurry.

The solid content in the positive electrode slurry may be in a range of about 70% to about 85% by weight.

The positive electrode slurry may have a viscosity in a range of about 1,000 cP to about 10,000 cP. For example, the positive electrode slurry may have a viscosity in a range of 1,000 cP to 5,000 cP, or 2,000 cP to 4,000 cP. The slurry may be manufactured to satisfy the viscosity range by controlling the amount of a dispersion medium added during the manufacture of the positive electrode slurry. When the positive electrode slurry satisfies the above viscosity range, the positive electrode stabilizing effect of the positive electrode additive may be improved or maximized.

When the viscosity of the positive electrode slurry is within the above range, the challenge of the slurry being lost when the slurry is applied onto a positive electrode current collector may not occur, and the challenge of the positive electrode active material layer becoming thick due to the application of an excessive amount of the slurry may not occur.

The viscosity of the positive electrode slurry may be measured at room temperature (25° C.) using, e.g., a B-type viscometer. However, the viscosity measuring device is not limited to what is described, and any device that can measure the viscosity of a liquid may be typically applied without limitation.

A method of manufacturing the positive electrode slurry may be performed by mixing the positive electrode active material, the binder, the conductive material, the dispersant, and the compound of Chemical Formula 1 as the positive electrode additive.

Hereinafter, a positive electrode for a rechargeable lithium battery according to one example embodiment of the present disclosure is described in more detail.

The positive electrode may include a positive electrode active material layer manufactured using the positive electrode slurry.

The positive electrode may be manufactured by preparing the positive electrode slurry, and coating a current collector with the positive electrode slurry to form a positive electrode active material layer.

In another example embodiment of the present disclosure, the rechargeable lithium battery includes a positive electrode including a positive electrode active material, and a negative electrode including a negative electrode active material. The positive electrode may include a positive electrode manufactured from the positive electrode slurry.

The rechargeable lithium battery may be applicable to, e.g., automobiles, mobile phones, and/or various types of electrical devices, but the present disclosure is not limited thereto.

Since the positive electrode has been described above, a detailed description of the positive electrode slurry and the positive electrode is omitted.

In one example embodiment, the negative electrode active material may include at least one of graphite and a Si composite.

When the negative electrode active material includes both a Si composite and graphite, the Si composite and graphite may be included in the form of a mixture. In this case, the Si composite and graphite may be included in a weight ratio in a range of about 1:99 to about 50:50 based on a total of 100 parts by weight of the Si composite and graphite. For example, the Si composite and graphite may be included in a weight ratio in a range of 3:97 to 20:80, 4:96 to 20:80, or 5:95 to 20:80.

The Si composite includes a core including Si-based particles and an amorphous carbon coating layer. For example, the Si-based particles may include one or more of a Si—C composite, SiOₓ (0<x≤2), and a Si alloy. For example, the Si—C composite may include a core including Si particles and crystalline carbon, and an amorphous carbon coating layer disposed on a surface of the core. The crystalline carbon may include, for example, graphite. For example, the crystalline carbon may include natural graphite, artificial graphite, or a mixture thereof.

The rechargeable lithium battery may further include an electrolyte.

The electrolyte includes the above-described non-aqueous organic solvent, and a lithium salt.

The non-aqueous organic solvent may include one or more of the non-aqueous organic solvents described above.

In one example embodiment, the non-aqueous organic solvent may be or include a mixture including ethylene carbonate (EC), ethyl methyl carbonate (EMC) and dimethyl carbonate (DMC) in a volume ratio in a range of about 10 to 30:10 to 30:40 to 80. Here, the volume ratio is a value based on a total of 100 volume % of ethylene carbonate (EC), ethyl methyl carbonate (EMC) and dimethyl carbonate (DMC). In the above range, in a rechargeable lithium battery including a positive electrode active material having a high nickel content, the battery lifespan may be further improved under high-voltage and high-temperature conditions.

The lithium salt according to one example embodiment of the present disclosure may include one or more of LiPF₆, LiClO₄, LiBF₄, lithium bis(fluorosulfonyl)imide (LiFSI), lithium bis(trifluoromethanesulfonyl)imide (LiTFSI), LiSO₃CF₃, LiBOB, LiFOB, LiDFBP, LiTFOP, LiPO₂F₂, LiSbF₆, LiAsF₆, LiAlO₂, LiAlCl₄, LiCl, LiI, LiN(SO₃C₂F₅)₂, Li(FSO₂)₂N, and LiC₄F₉SO₃. According to one example embodiment, LiPF₆ may be used as the lithium salt.

The lithium salt may have a concentration of 0.1 M to 3.0 M. For example, the lithium salt may have a concentration of about 0.5 M or more, or about 1.0 M or more. The lithium salt may have a concentration of about 3.0 M or less, about 2.5 M or less, or about 2.0 M or less. In the present disclosure, when the concentration of the lithium salt is in a range of about 0.1 M to about 2.0 M, the conductivity of the electrolyte and the viscosity of the electrolyte may be maintained as desired.

Hereinafter, examples and comparative examples of the present disclosure are described below. However, it should be understood that the following examples are only examples of the present disclosure, and are not intended to limit the present disclosure.

### Synthesis Example 1

A magnetic bar and a thermometer were installed in a 500 mL round-bottom flask, and tetrafluorosuccinic acid (100 mmol) and imidazole (250 mmol) were mixed with 200 mL of methylene chloride, and then stirred in an ice bath for 5 minutes. Thereafter, chlorotrimethylsliane (250 mmol) was added dropwise and stirred at room temperature for 20 hours. The mixture whose reaction was completed was filtered to remove the imidazole salt, and the filtrate was then concentrated and dried with a vacuum pump to obtain a compound represented by Chemical Formula A.

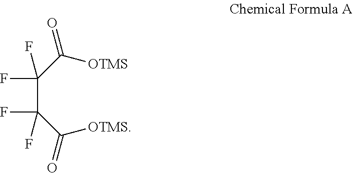

Next, the compound represented by Chemical Formula A (40 mmol) and lithium tetrafluoroborate (42 mmol) were mixed in 100 mL of acetonitrile as a solvent in a 250 mL round-bottom flask, and stirred at 70° C. for 12 hours. After the mixed solution whose reaction was completed was filtered, the crystals were dried under vacuum to finally obtain a compound represented by the following Chemical Formula 1-1.

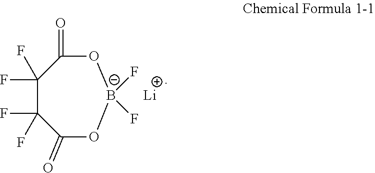 [SMILES: O=C1O[B-](F)(F)OC(=O)C(F)(F)C1(F)F ; [Li+]]

### Synthesis Example 2

A compound represented by the following Chemical Formula 2 was obtained in the same manner as in Synthesis Example 1, except that difuloromalonic acid (250 mmol) was used instead of tetrafluorosuccinic acid.

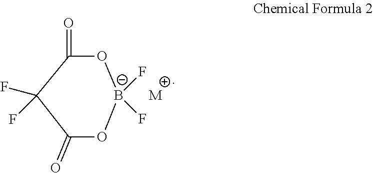

### EXAMPLES AND COMPARATIVE EXAMPLES

### Example 1

### (1) Preparation of Positive Electrode Slurry

97% by weight of LiNi_{0.91}Co_{0.08}Al_{0.01}O₂ as a positive electrode active material, 0.5% by weight of artificial graphite powder as a conductive material, 1% by weight of carbon black (Ketjen black), and 1.5% by weight of polyvinylidene fluoride (PVdF) as a binder were mixed, and 0.2 parts by weight of the additive of Chemical Formula 1-1 was mixed with respect to 100 parts by weight of the positive electrode active material, and then added to N-methyl-2-pyrrolidone (NMP). Thereafter, the resulting mixture was stirred for 30 minutes using a mechanical stirrer to prepare a positive electrode slurry.

### (2) Manufacture of Rechargeable Lithium Battery

The slurry was applied to a thickness of approximately 60 μm on a 20 μm-thick aluminum current collector using a doctor blade, dried in a hot air dryer at 100° C. for 0.5 hour, dried again under vacuum at 120° C. for 4 hours, and then roll-pressed to manufacture a positive electrode.

98% by weight of a negative electrode active material in which graphite and a Si composite were mixed in a weight ratio of 95.8:4.2, 1% by weight of a styrene-butadiene rubber (SBR), and 1% by weight of carboxymethyl cellulose (CMC) were mixed, and added to distilled water. Thereafter, the resulting mixture was stirred for 60 minutes using a mechanical stirrer to prepare a slurry of a negative electrode active material. The slurry was applied to a thickness of approximately 60 μm on a 10 μm-thick copper current collector using a doctor blade, dried in a hot air dryer at 100° C. for 0.5 hour, dried again under vacuum at 120° C. for 4 hours, and then roll-pressed to manufacture a negative electrode.

The positive and negative electrodes and a separator made of a polyethylene material and having a thickness of 16 μm were assembled to manufacture an electrode assembly, and the electrolyte was injected to manufacture a cylindrical rechargeable lithium battery. The electrolyte was prepared by dissolving 1.25 M LiPF₆ in a carbonate-based solvent in which ethylene carbonate (EC), ethyl methyl carbonate (EMC), and dimethyl carbonate (DMC) were mixed in a volume ratio of 20:30:50 and mixing the resulting mixture.

### Example 2

A positive electrode slurry and a battery were manufactured in the same manner as in Example 1, except that the content of Chemical Formula 1-1 used in Example 1 was included in an amount of 0.5 parts by weight based on 100 parts by weight of the positive electrode active material.

### Example 3

A positive electrode slurry and a battery were manufactured in the same manner as in Example 1, except that the content of Chemical Formula 1-1 used in Example 1 was included in an amount of 1.0 parts by weight based on 100 parts by weight of the positive electrode active material.

### Example 4

A positive electrode slurry and a battery were manufactured in the same manner as in Example 1, except that the content of Chemical Formula 1-1 used in Example 1 was included in an amount of 2.0 parts by weight based on 100 parts by weight of the positive electrode active material.

### Comparative Example 1

An electrolyte and a battery were manufactured in the same manner as in Example 1, except that the compound of Chemical Formula 1-1 used in Example 1 was not included.

### Comparative Example 2

A positive electrode slurry and a battery were manufacture in the same manner as in Example 1, except that 0.5 parts by weight of the compound of Chemical Formula 2 was used instead of the compound of Chemical Formula 1-1.

### Comparative Example 3

### (1) Preparation of Electrolyte

1.25 M of LiPF₆ was dissolved in a non-aqueous organic solvent in which ethylene carbonate, ethyl methyl carbonate, and dimethyl carbonate were mixed in a volume ratio of 20:30:50 based on a total of 100% by volume of the ethylene carbonate, ethyl methyl carbonate, and dimethyl carbonate as a carbonate solvent, and 0.2% by weight of the compound of Chemical Formula 1-1 was added thereto. Thereafter, the resulting mixture was mixed to prepare an electrolyte.

### (2) Manufacture of Rechargeable Lithium Battery

97% by weight of LiNi_{0.91}Co_{0.08}Al_{0.01}O₂ as a positive electrode active material, 0.5% by weight of artificial graphite powder as a conductive material, 1% by weight of carbon black (Ketjen black), and 1.5% by weight of polyvinylidene fluoride (PVdF) as a binder were mixed, and added to N-methyl-2-pyrrolidone (NMP). Thereafter, the resulting mixture was stirred for 30 minutes using a mechanical stirrer to manufacture a positive electrode slurry.

The slurry was applied to a thickness of approximately 60 μm on a 20 μm-thick aluminum current collector using a doctor blade, dried in a hot air dryer at 100° C. for 0.5 hour, dried again under vacuum at 120° C. for 4 hours, and then roll-pressed to manufacture a positive electrode.

98% by weight of a negative electrode active material in which graphite and a Si composite were mixed at a weight ratio of 95.8:4.2, 1% by weight of a styrene-butadiene rubber (SBR), and 1% by weight of carboxymethyl cellulose (CMC) were mixed, and then added to distilled water. Thereafter, the resulting mixture was stirred for 60 minutes using a mechanical stirrer to prepare a slurry of a negative electrode active material. The slurry was applied to a thickness of approximately 60 μm on a 10 μm-thick copper current collector using a doctor blade, dried in a hot air dryer at 100° C. for 0.5 hour, dried again under vacuum at 120° C. for 4 hours, and then roll-pressed to manufacture a negative electrode.

The positive and negative electrodes and a separator made of a polyethylene material and having a thickness of 16 μm were assembled to manufacture an electrode assembly, and the electrolyte was injected to manufacture a cylindrical rechargeable lithium battery.

### Evaluation Examples

The rechargeable lithium batteries were evaluated using the following method.

### Evaluation Example 1: DCIR Increase Rate after High-Temperature Storage

For the rechargeable lithium batteries according to the examples and comparative examples, the initial direct current internal resistance (DCIR) was measured as AV/AI (change in voltage/change in current) value, and then the maximum energy state inside the battery was set to a fully charged state (SOC 100%). In this state, the batteries were stored at 60° C. for 90 days, the DCIR was measured, and the DCIR increase rate (%) was calculated using the following equation. The results are shown in Table 1 below.

$$DCIR increase rate ( \% ) = ( DCIR after 90 days at 60 ° C . / Initial DCIR ) \times 100.$$

### Evaluation Example 2: Capacity Retention Rate after High-Temperature Storage

The rechargeable lithium batteries of the examples and comparative examples were subjected to 0.33 C CC/CV charging (4.25 V, 0.05 C CUT-OFF) and 0.33 C CC discharging (2.8 V CUT-OFF) at 25° C., and this process was repeated three times to measure the discharge capacity C1 the third time. The charged rechargeable lithium batteries were stored at 60° C. for 90 days, left at room temperature for another 2 hours, and then subjected to 0.33 C CC discharging (2.8 V CUT-OFF) to measure the discharge capacity C2. The capacity retention rate was calculated using the following equation. The results are shown in Table 1 below.

$$Capacity retention rate ( \% ) = C 2 / C 1 \times 100 ( \% ) .$$

TABLE 1

| | | | DCIR | | | Capacity | | |
|---|---|---|---|---|---|---|---|---|
| | | | | After | | | After | |
| | | | | storage at | | | storage at | Capacity |
| | | | | high | Increase | | high | retention |
| | Compound | | Initial | temperatures | rate | Initial | temperatures | rate |
| | Classification | Content | (mΩ) | (mΩ) | (%) | (Ah) | (Ah) | (%) |
| Example 1 | Chemical | 0.2 parts | 8.85 | 10.97 | 124.0 | 7.45 | 6.89 | 92.48 |
| | Formula 1-1 | by weight* | | | | | | |
| Example 2 | Chemical | 0.5 parts | 9.13 | 10.85 | 118.8 | 7.45 | 6.90 | 92.62 |
| | Formula 1-1 | by weight* | | | | | | |
| Example 3 | Chemical | 1.0 parts | 9.22 | 10.77 | 116.8 | 7.44 | 6.97 | 93.68 |
| | Formula 1-1 | by weight* | | | | | | |
| Example 4 | Chemical | 2.0 parts | 9.57 | 10.90 | 113.9 | 7.44 | 6.93 | 93.15 |
| | Formula 1-1 | by weight* | | | | | | |
| Comparative | — | — | 8.91 | 13.30 | 149.3 | 7.44 | 6.62 | 88.98 |
| Example 1 | | | | | | | | |
| Comparative | Chemical | 0.5 parts | 9.53 | 13.49 | 141.6 | 7.44 | 6.75 | 90.73 |
| Example 2 | Formula 2 | by weight* | | | | | | |
| Comparative | Chemical | 0.2% by | 8.97 | 11.74 | 130.9 | 7.45 | 6.765 | 90.81 |
| Example 3 | Formula 1-1 | weight** | | | | | | |

In Table 1:
*Content of compound based on 100 parts by weight of positive electrode active material
**Content of compound in electrolyte.

### SUMMARY

Referring to Table 1 above, the rechargeable lithium batteries having the positive electrodes manufactured with the positive electrode slurries of the examples can be sufficiently expected to have improved lifespan and performance at high temperatures even if the positive electrode slurries include a high-nickel positive electrode active material based on the results of Evaluation Examples 1 and 2.

However, referring to Table 1 above, Comparative Example 1, which did not include the compound of Chemical Formula 1 of the present disclosure, and Comparative Example 2, which included a compound other than Chemical Formula 1 of the present disclosure, showed a weak effect of improving the lifespan and performance at high temperatures even though the rechargeable lithium batteries included a high-nickel positive electrode active material according to the results of Evaluation Examples 1 and 2. Also, when the compound of Chemical Formula 1 of the present disclosure was included in the electrolyte, the rechargeable lithium batteries had a relatively weak effect of improving the lifespan and performance at high temperatures.

A positive electrode slurry for a rechargeable lithium battery according to one example embodiment can provide an effect of improving the performance and lifespan of a battery at high temperatures by providing a positive electrode that provides a high capacity retention rate and a low resistance increase rate after storage at high temperatures.

Although the present disclosure has been described above with reference to the example embodiments thereof, the present disclosure is not limited thereto. Therefore, it should be understood that various changes and modifications can be made by those skilled in the art to which the present disclosure pertains within the scope of the claims, the detailed description of the present disclosure, and the accompanying drawings, which also fall within the scope of the present disclosure.

What is claimed is:

1. A positive electrode slurry for a rechargeable lithium battery, the positive electrode slurry comprising a positive electrode active material, a binder, a positive electrode additive, and a conductive material,
wherein the positive electrode additive includes a compound represented by Chemical Formula 1: 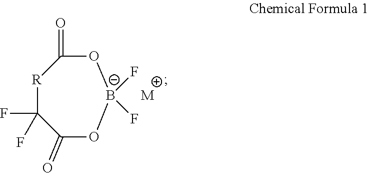
wherein:
R comprises at least one fluorine-substituted C1 to C20 alkylene group, and
M comprises an alkali metal.

2. The positive electrode slurry of claim 1, wherein R comprises at least one fluorine-substituted C1 to C3 alkylene group.

3. The positive electrode slurry of claim 1, wherein R comprises one of —CHF—, —CF₂—, —C₂HF₃—, —C₂H₂F₂—, —C₂H₃F—, —C₂F₄—, —C₃F₆—, —C₃H—F₅—, —C₃H₂F₄—, —C₃H₃F₃—, —C₃H₄F₂—, —C₃H₅F—, —C₄F₈—, —C₄HF₇—, —C₄H₂F₆—, —C₄H₃F₅—, —C₄H₄F₄—, —C₄H₅F₃—, —C₄H₆F₂—, —C₄H₇F—, —C₅F₁₀—, —C₅HF₉—, —C₅H₂F₈—, —C₅H₃F₇—, —C₅H₄F₆—, —C₅H₅F₅—, —C₅H₆F₄—, —C₅H₇F₃—, —C₅H₈F₂—, and —C₅H₉F—.

4. The positive electrode slurry of claim 1, wherein the compound of Chemical Formula 1 comprises one or more compounds of the following Chemical Formulas 1-1 and 1-2:

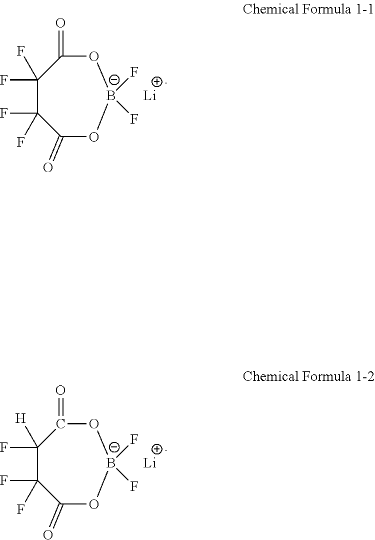 [SMILES: O=C1O[B-](F)(F)OC(=O)C(F)(F)C1(F)F ; [Li+] ; O=C1O[B-](F)(F)OC(=O)C(F)(F)C1F ; [Li+]]

5. The positive electrode slurry of claim 1, wherein the compound of Chemical Formula 1 is included in an amount in a range of about 0.1 parts by weight to about 10 parts by weight based on 100 parts by weight of the positive electrode active material.

6. The positive electrode slurry of claim 1, wherein the positive electrode active material comprises a lithium nickel-based oxide having a nickel content of about 80 mol % or more based on 100 mol % of metals excluding lithium.

7. The positive electrode slurry of claim 1, wherein the positive electrode active material comprises a lithium nickel-based oxide represented by Chemical Formula 2: 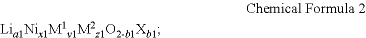
wherein 0.9<a1<1.8, 0.3<x1≤1, 0≤y1≤0.7, 0≤z1≤0.7, 0.9<x1+y1+z1≤1.1, and 0<b1≤0.1,
M¹ and M² each independently comprises one or more of Al, B, Ba, Ca, Ce, Co, Cr, Cu, Fe, Mg, Mn, Mo, Nb, Si, Sn, Sr, Ti, V, W, and Zr, and
X comprises one or more of F, P, and S.

8. The positive electrode slurry of claim 6, wherein the lithium nickel-based oxide is included in an amount in a range of about 95% by weight or more in the positive electrode active material.

9. The positive electrode slurry of claim 1, wherein:
the binder comprises a fluorine-based binder, and
the conductive material comprises one or more of artificial graphite and carbon black.

10. The positive electrode slurry of claim 1, wherein the positive electrode active material, the conductive material, and the binder are included in amounts in a range of about 90 parts by weight to about 99 parts by weight, a range of about 0.5 parts by weight to about 5 parts by weight, and a range of about 0.5 parts by weight to about 5 parts by weight, respectively, based on a total of 100 parts by weight of the positive electrode active material, the conductive material, and the binder.

11. The positive electrode slurry of claim 1, further comprising a dispersion medium,
wherein the dispersion medium is included in an amount in a range of about 15% by weight to about 30% by weight in the positive electrode slurry, and
the solid content in the positive electrode slurry is in a range of about 70% by weight to about 85% by weight.

12. A rechargeable lithium battery comprising:
a positive electrode; and
a negative electrode including a negative electrode active material,
wherein the positive electrode is manufactured based on the positive electrode slurry as defined in claim 1.

13. The rechargeable lithium battery of claim 12, wherein the negative electrode active material comprises at least one of graphite and a Si composite.

14. The rechargeable lithium battery of claim 12, wherein the rechargeable lithium battery is a cylindrical, prismatic, pouch-type or coin-type battery.

15. A positive electrode manufactured based on the positive electrode slurry as defined in claim 1.
